(19) United States
(12) Patent Application Publication
(10) Pub. No.: US 2010/0226044 A1
(43) Pub. Date: Sep. 9, 2010

(54) HEAD SLIDER AND STORAGE MEDIUM DRIVING DEVICE

(75) Inventor: Takeshi IWASE, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/783,371

(22) Filed: May 19, 2010

Related U.S. Application Data
(63) Continuation of application No. PCT/JP2007/072370, filed on Nov. 19, 2007.

(51) Int. Cl. G11B 5/60

(52) U.S. Cl. 360/234.3; G9B/5.229

(57) ABSTRACT

According to one embodiment, a head slider, includes: a slider main body; an insulating nonmagnetic film laminated on an end surface of the slider main body at an air outflow side; a head element embedded in the nonmagnetic film; a heater embedded in the nonmagnetic film in association with the head element; a conductive terminal formed on an end surface of the nonmagnetic film at the air outflow side; a conductive pattern configured to electrically connect the heater and the conductive terminal with each other; and a radiator configured to contact the conductive pattern and dissipate heat transmitted from the conductive pattern.

### CROSS-REFERENCE TO RELATED APPLICATIONS

This application is a continuation of PCT international application Ser. No. PCT/JP2007/072370 filed on Nov. 19, 2007 which designates the United States, incorporated herein by reference.

### BACKGROUND

1. Field

One embodiment of the invention relates to a storage medium driving device such as a hard disk drive (HDD), and more particularly, to a head slider that is embedded in a storage medium driving device.

2. Description of the Related Art

An electromagnetic conversion element is embedded in an element-embedded-film provided to an end of a head slider at an air flow side. For example, as disclosed in Japanese Patent Application Publication (KOKAI) No. 2007-12108, a heater is mounted in the electromagnetic conversion element. The heater causes thermal expansion of the head slider on the basis of generated heat. An end of the electromagnetic conversion element protrudes at a surface of the head slider. The flying height of the electromagnetic conversion element is controlled on the basis of the protrusion. The electromagnetic conversion element can be placed the closest to a surface of the magnetic disk, and a recording density of magnetic information increases.

In the electromagnetic conversion element, a radiator is also mounted. The heat generated from the heater is transmitted to the radiator and is emitted from the radiator to a surrounding insulating layer. As a result, the excessive increase in the temperature of the heater can be avoided. A wiring pattern is connected to the heater. The wiring pattern is connected to a conductive terminal formed on an end surface of the head slider at an air outflow side. The conductive terminal is connected to a conductive terminal on a head suspension by a bonding material such as solder. In this way, a current is supplied to the heater. As a result, the heater can generate the heat.

The radiator is formed of a conductive material. If the heater and the radiator contact with each other, a current is supplied to the radiator. Control precision of the protrusion amount based on the generation of the heat of the radiator is lowered. Therefore, an insulating layer needs to be provided between the heater and the radiator. Since the wiring pattern is formed of a conductive material having high thermal conductivity such as copper, the heat from the heater may be transmitted through the wiring pattern and to the conductive terminal. This heat may melt the solder or cause migration with the solder without melting the solder.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view of an internal structure of a hard disk drive (HDD) according to an embodiment of the invention;

FIG. 2 is an exemplary enlarged perspective view of a flying head slider embedded in the HDD in the embodiment;

FIG. 3 is an exemplary schematic front view of an electromagnetic conversion element mounted in the flying head slider in the embodiment;

FIG. 4 is an exemplary cross sectional view taken along the line 4-4 of FIG. 3 in the embodiment;

FIG. 5 is an exemplary partially enlarged perspective view of a bonding material connecting the flying head slider to a flexure in the embodiment; and

FIG. 6 is an exemplary partially transparent lateral view of an end surface of the flying head slider at an air outflow side in the embodiment.

### DETAILED DESCRIPTION

Various embodiments according to the invention will be described hereinafter with reference to the accompanying drawings. In general, according to one embodiment of the invention, a head slider, comprises: a slider main body; an insulating nonmagnetic film laminated on an end surface of the slider main body at an air outflow side; a head element embedded in the nonmagnetic film; a heater embedded in the nonmagnetic film in association with the head element; a conductive terminal formed on an end surface of the nonmagnetic film at the air outflow side; a conductive pattern configured to electrically connect the heater and the conductive terminal with each other; and a radiator configured to contact the conductive pattern and dissipate heat transmitted from the conductive pattern.

According to another embodiment of the invention, a storage medium driving device, comprises: a support body; a slider main body supported to the support body; an insulating nonmagnetic film laminated on an end surface of the slider main body at an air outflow side; a head element embedded in the nonmagnetic film; a heater embedded in the nonmagnetic film in association with the head element; a conductive terminal on an end surface of the nonmagnetic film at the air outflow side; a conductive pattern configured to electrically connect the heater and the conductive terminals with each other; and a radiator configured to contact the conductive pattern and dissipate heat transmitted from the conductive pattern.

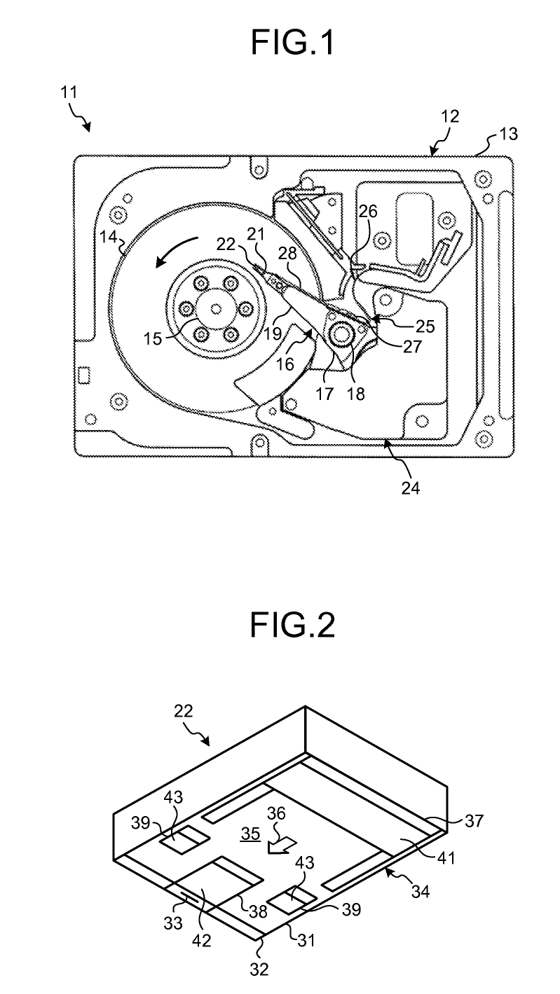

FIG. 1 schematically illustrates an internal structure of a hard disk drive (HDD) 11 as a specific example of a storage medium driving device according to an embodiment of the invention. The HDD 11 comprises a casing, that is, a housing 12. The housing 12 has a box-shaped base 13 and a cover (not illustrated). The base 13 defines, for example, a flat internal space, or storage space. The base 13 may be formed by casting of a metal material such as Aluminum. The cover is connected to an opening of the base 13. The storage space between the cover and the base 13 is closed hermetically. For example, the cover may be made of one plate material by press working.

In the storage space, at least one magnetic disk 14 is stored as a storage medium. The magnetic disk 14 is mounted on a rotation shaft of a spindle motor 15. The spindle motor 15 can rotate the magnetic disk 14 at high speed, such as 5,400 round per minutes (rpm), 7,200 rpm, 10,000 rpm, or 15,000 rpm.

In the storage space, a carriage 16 is also provided. The carriage 16 comprises a carriage block 17, which is rotatably connected to a support shaft 18 extending in the perpendicular direction. In the carriage block 17, a plurality of carriage arms 19 are defined extending horizontally from the support shaft 18. For example, the carriage block 17 may be made of Aluminum by extrusion.

Attached to the end of each of the carriage arms 19 is a head suspension 21. The head suspension 21 extends frontward from the end of the carriage arm 19. The head suspension 21 has a flexure (to be described in detail below) attached thereto. At the end of the head suspension 21, a gimbal spring is defined in the flexure. With the operation of the gimbal spring, the flying head slider 22 can change the attitude relative to the head suspension 21. On the flying head slider 22, a magnetic head, that is, an electromagnetic conversion element is mounted.

When airflow is generated on the surface of the magnetic disk 14 by rotation of the magnetic disk 14, the airflow acts so that the positive pressure (buoyant force) and the negative pressure act on the flying head slider 22. When the buoyant force and the negative pressure are equal to a pressing force of the head suspension 21, the flying head slider 22 can be kept floated with relatively high rigidity during rotation of the magnetic disk 14.

When the carriage 16 rotates around the support shaft 18 while the flying head slider 22 is flying, the flying head slider 22 can move along the radial line of the magnetic disk 14. Consequently, the electromagnetic conversion element on the flying head slider 22 can come across the data zone between innermost recording track and the outermost recording track. Then, the electromagnetic conversion element on the flying head slider 22 can be positioned on a target recording track.

To the carriage block 17, for example, a power source such as a voice coil motor (VCM) 24 is connected. The action of the VCM 24 rotates the carriage block 17 around the support shaft 18. Such rotation of the carriage block 17 realizes swinging of the rotating of the carriage arm 19 and the head suspension 21.

As can be seen from FIG. 1, on the carriage block 17, a flexible printed circuit board module 25 is disposed. The flexible printed circuit board module 25 comprises a head IC (integrated circuit) mounted on a flexible printed circuit board 26. A head IC 27 is connected to a read head element and a write head element of the electromagnetic conversion element. When the head IC 27 is connected to the read element and the write element, a flexure 28 is used. The flexure 28 connects the flying head slider 22 and the flexible printed circuit board 26 with each other. The head suspension 21 is formed in a so-called long-tail shape.

When magnetic information is read, a sense current is supplied from the head IC 27 to a read head element of the electromagnetic conversion element. Likewise, when the magnetic information is written, a write current is supplied from the head IC 27 to a write head element of the electromagnetic conversion element. A current value of the sense current is set to a specific value. To the head IC 27, a current is supplied form a small circuit board disposed in the storage space or a printed circuit board (not illustrated) mounted to the rear side of a bottom plate of the base 13.

FIG. 2 illustrates the flying head slider 22 according to the embodiment. The flying head slider 22 has a slider main body 31 that is formed into a flat rectangular parallelepiped. On the end surface of the slider main body 31 at the air outflow side, an insulating nonmagnetic film, that is, an element-embedded-film 32 is deposited. The above-described electromagnetic conversion element 33 is embedded in the element-embedded-film 32. Details of the electromagnetic conversion element 33 are described later.

The slider main body 31 may be made of hard nonmagnetic material such as AL₂O₃—Tic (AlTic). The element-embedded-film 32 may be made of relatively soft insulating nonmagnetic material such as AL₂O₃ (Alumina). The slider main body 31 faces the magnetic disk 14 at a medium facing surface, that is, a flying surface 34. On the flying surface 34, a flat base surface 35 is provided as a reference surface. When the magnetic disk 14 is rotated, airflow 36 acts on the flying surface 34 from the back end to the front end of the slider main body 31.

On the flying surface 34, one front rail 37 is formed so as to be elevated from the base surface 35 on the upstream of the airflow 36 or the air inflow side. The front rail 37 extends along the air inflow end of the base surface 35 in the width direction of the slider. Likewise, on the flying surface 34, a rear rail 38 is formed so as to be elevated from the base surface 35 at the air outflow side that is the downstream side of the airflow. The rear rail 38 is arranged at the center position of the slider width direction.

On the flying surface 34, a pair of left and right auxiliary rear rails 39, 39 are further formed so as to be elevated from the base surface 35 at the air outflow side. The auxiliary rear rails 39 and 39 are disposed along the left and right edges of the base surface 35. As a result, the auxiliary rear rails 39, 39 are disposed at an interval in the slider width direction. The rear rail 38 is disposed between the auxiliary rear rails 39, 39.

On the top surfaces of the front rail 37, the rear rail 38, and the auxiliary rear rails 39, 39, air bearing surfaces (ABS) 41, 42, and 43 are defined. Air inflow ends of the ABSs 41, 42, and 43 are connected by steps to the top surfaces of the rails 37, 38, and 39. The airflow 36 generated by the rotation of the magnetic disk 14 is received by the flying surface 34. At this time, relatively large positive pressure, i.e., buoyant force, is generated on the ABSs 41, 42, and 43 due to the steps. Besides, a large negative pressure is generated at the rear side, or backside of the front rail 37. The balance between these buoyant force and negative pressure is used as a basis to establish flying attitude of the flying head slider 22.

On the air outflow side of the ABS 42, the electromagnetic conversion element 33 is embedded in the rear rail 38. The electromagnetic conversion element 33 has, for example, a reading element and a writing element so that a reading gap of the reading head element and a writing gap of the writing head element are faced on the element-embedded-film 32. On the air outflow side of the ABS 42, a hard protective film may be formed on the surface of the element-embedded-film 32. Such a hard protective film covers the end of the reading gap and the end of writing gap exposed on the surface of the element-embedded-film 32. The protective film may be, for example, diamond-like carbon (DLC). However, the type of the flying head slider 22 is not limited thereto.

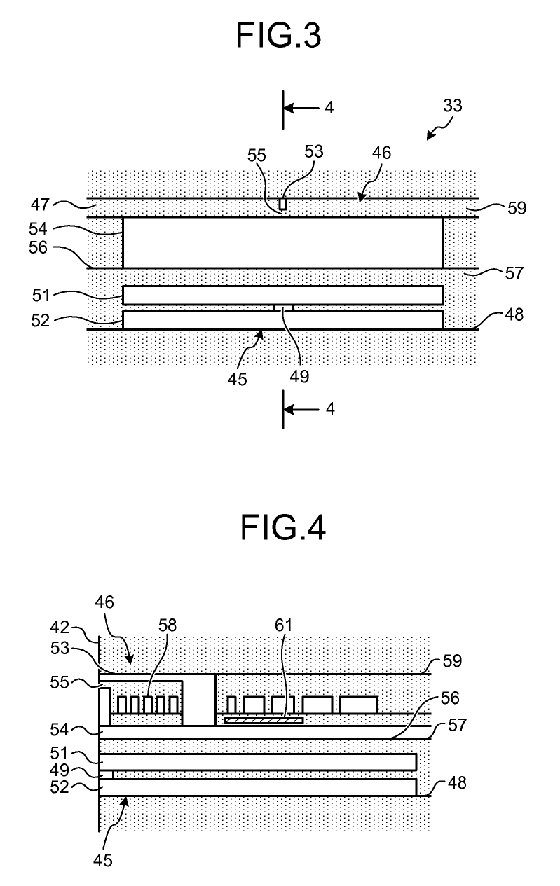

FIG. 3 specifically illustrates an exemplary electromagnetic conversion element 33. The electromagnetic conversion element 33 comprises a current-perpendicular-to-the-plane (CPP) structure reading element 45 and a thin film magnetic head element 46. As already known, the CPP structure reading element 45 can detect binary information on the basis of resistance that varies according to magnetic field acting from the magnetic disk 14. For example, the thin film magnetic head element 46 can write the binary information to the magnetic disk 14 using a magnetic field generated in a conductive coil pattern (not illustrated). The CPP structure reading element 45 and the thin film magnetic head element 46 are interposed between an alumina film 47 and an alumina film 48. The alumina film 47 constitutes an upper layer of the element-embedded-film 32, that is, an overcoat film. The alumina film 48 constitutes a lower layer of the element-embedded-film 32, that is, an undercoat film.

The CPP structure reading element 45 comprises a magneto resistance effect film 49 such a spin valve film or a tunnel junction film. The magneto resistance effect film 49 is interposed between an upper electrode 51 and a lower electrode 52. The upper electrode 51 and the lower electrode 52 contact an upper boundary surface and a lower boundary surface of the magneto resistance effect film 49 at the end exposed to the surface of the slider main body 31. A sense current is supplied to the magneto resistance effect film 49 by the action of the upper electrode 51 and the lower electrode 52. The upper electrode 51 and the lower electrode 52 may have soft magnetic property as well as conductivity. If each of the upper electrode 51 and the lower electrode 52 is made of a soft magnetic material with conductivity, such as permalloy (NiFe alloy), the upper electrode 51 and the lower electrode 52 can function as upper and lower shield layers of the CPP structure reading element 45 at the same time. In this way, the upper electrode 51 and the lower electrode 52 define the reading gap.

The thin film magnetic head element 46 comprises an upper magnetic pole layer 53 that faces the magnetic disk 14 at the end at the surface of the slider main body 31, and a lower magnetic pole layer 54 that faces the magnetic disk 14 at the end exposed to the surface of the slider main body 31. Each of the upper magnetic pole layer 53 and the lower magnetic pole layer 54 may be formed of FeN or NiFe. The upper magnetic pole layer 53 and the lower magnetic pole layer 54 cooperate with each other and constitute a magnetic core of the thin film magnetic head element 46.

A nonmagnetic gap layer 55 made of Alumina is interposed between the upper magnetic pole layer 53 and the lower magnetic pole layer 54. As known already, if the magnetic field is generated by the thin film coil pattern, by the action of the nonmagnetic gap layer 55, a magnetic flux that comes and goes between the upper magnetic pole layer 53 and the lower magnetic pole layer 54 leaks into the magnetic disk 14. The leaked magnetic flux forms a gap magnetic field, that is, a recording magnetic field. In this way, the upper magnetic pole layer 53 and the lower magnetic pole layer 54 define the write gap.

Referring to FIG. 4, the lower magnetic pole layer 54 is expanded along an arbitrary reference plane 56 on the upper electrode 51. The reference plane 56 is defined by a surface of a nonmagnetic layer 57 made of Alumina. The nonmagnetic layer 57 may be laminated on the upper electrode 51 in a uniform thickness. The nonmagnetic layer 57 cuts magnetic coupling between the upper electrode 51 and the lower magnetic pole layer 54.

On the lower magnetic pole layer 54, a thin film coil pattern 58 is disposed. The thin film coil pattern 58 is expanded in a spiral shape along one plane. The thin film coil pattern 58 is embedded in an insulating layer 59 on the lower magnetic pole layer 54. The upper magnetic pole layer 53 is formed on a surface of the insulating layer 59. The upper magnetic pole layer 53 is electrically connected to the lower magnetic pole layer 54 at a central position of the thin film coil pattern 58. If a current is supplied to the thin film coil pattern 58, a magnetic flux is generated in the upper magnetic pole layer 53 and the lower magnetic pole layer 54.

In the element-embedded-film 32, a heater is embedded associated with the electromagnetic conversion elements 33. The heater is formed of heating wire 61 embedded in the insulating layer 59 between the lower magnetic pole layer 54 and the thin film coil pattern 58. The heating wire 61 may be expanded along a virtual plane orthogonal to the air bearing surface 42. The heating wire 61 may be made of, for example, W (tungsten) and TiW (titan tungsten). The heating wire 61 is connected to an arbitrary power supply circuit. The power supply circuit supplies power to the heating wire 61. The heating wire 61 generates heat in accordance with the supplied power. The temperature of the heating wire 61 is determined by the power amount.

The thin film coil pattern 58 has a large thermal expansion coefficient as compared with the element-embedded-film 32. Therefore, if the power is supplied to the heating wire 61, the thin film coil pattern 58 is expanded based on the heat of the heating wire 61. As a result, the front end of the thin film coil pattern 58 protrudes on the surface of the element-embedded-film 32, which is a so-called projection. Thus, the CPP structure reading element 45 and the thin film magnetic head element 46 are displaced toward the magnetic disk 14. That is, a heat actuator is constructed. The flying height of the thin film magnetic head element 46 is determined in accordance with the amount of projection.

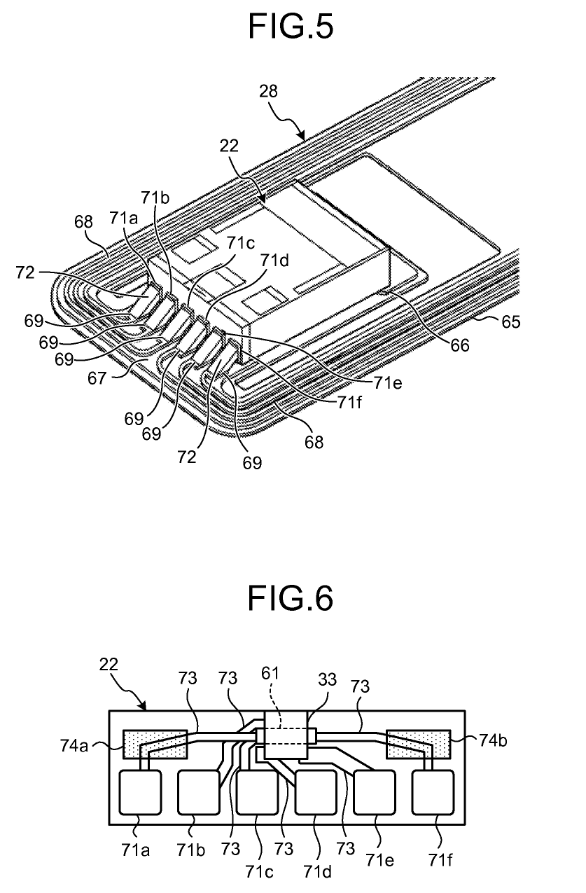

As illustrated in FIG. 5, the flexure 28 comprises a fixed plate 65 that is fixed on the head suspension 21. The fixed plate 65 is connected to a support plate 66 to receive the flying head slider 22. Each of the fixed plate 65 and the support plate 66 is formed of one plate spring member. The plate spring is made of stainless steel having a uniform thickness. The support plate 66, that is, the flying head slider 22 is received in a protrusion defined on the surface of the head suspension 21 at a back surface. As a result, the flying head slider 22 can change the attitude relative to the fixed plate 65.

The flexure 28 comprises a base insulating film 67. The base insulating film 67 is partially adhered on the surface of the support plate 66 or the fixed plate 65. On the surface of the base insulating film 67, six stripes of conductive layers that are grown in parallel, that is, wiring patterns 68 are formed. The wiring patterns 68 maybe made of a conductive material such as copper (Cu). In the base insulating film 67, for example, a resin material such as a polyimide resin may be used.

At further air outflow side from the end surface of the flying head slider 22 at the air outflow side, 6 conductive pads 69 are formed on the surface of the base insulating film 67. Each conductive pad 69 is connected to each wiring pattern 68. On the end surface of the flying head slider 22 at the air outflow side, for example, first to sixth conductive pads 71a to 71f are formed. The first to sixth conductive pads 71a to 71f are connected to the corresponding conductive pads 69 by a bonding material, that is, solder 72. The conductive pads 69 and 71 are formed of conductive materials, such as copper.

As illustrated in FIG. 6, the first conductive pad 71a and the sixth conductive pad 71f are electrically connected to the heating wire 61. The second conductive pad 71b and the third conductive pad 71c are electrically connected to the thin film coil pattern 58. Likewise, the fourth conductive pad 71d and the fifth conductive pad 71e are electrically connected to the upper electrode 51 and the lower electrode 52. At the time of the connection, conductive patterns that extend in the element-embedded-film 32, that is, wiring patterns 73 are used. The wiring patterns 73 are formed of a conductive material such as copper.

In this case, radiators 74a and 74b are provided to contact the wiring pattern 73 connecting the first conductive pad 71a and the heating wire 61 with each other and the wiring pattern 73 connecting the sixth conductive pad 71f and the heating wire 61 with each other, respectively. The radiators 74a and 74b may be embedded in the element-embedded-film 32. As a formation material of the radiators 74a and 74b, a conductive metal material such as copper, Au (Gold), Ag (Silver), and/or Al (Aluminum) is used. A distance between the radiator 74a and the heating wire 61 is set to be greater than a distance between the radiator 74a and the first conductive pad 71a. Likewise, a distance between the radiator 74b and the heating wire 61 is set to be greater than a distance between the radiator 74b and the sixth conductive pad 71f.

In this case, each of the radiators 74a and 74b is formed of a rectangular parallelepiped thin plate. The thin plate may be expanded along the virtual plane parallel to the end surface of the flying head slider 22 at the air outflow side. The width of the thin plate on the virtual plane is set to be more than the width of the wiring pattern 73. The distance between the radiators 74a and 74b and the air outflow side end surface maybe set to be larger or smaller than the distance between the wiring pattern 73 and the air outflow side end surface. The radiators 74a and 74b may be disposed on the virtual plane comprising the wiring pattern 73.

In the HDD 11, when the thin film magnetic head element 46 is protruded, the power is supplied to the heating wire 61. At this time, the heating wire 61 generates heat. Since the wiring pattern 73 is formed of material having high thermal conductivity, the heat is also transmitted to the wiring pattern 73. The wiring patterns 73 between the heating wire 61 and the first and sixth conductive pads 71a and 71f contact the radiators 74a and 74b. The heat is transmitted from the wiring pattern 73 to the radiators 74a and 74b. The radiators 74a and 74b emit the heat to the element-embedded-film 32. As a result, the transmission of the heat from the wiring pattern 73 to the first conductive pad 71a or the sixth conductive pad 71f is maximally suppressed. Thus, the solder 72 is avoided from being melted or migrated.

Since the radiators 74a and 74b are formed of a conductive metal material, the resistivity of the radiators 74a and 74b is set low. For example, even though the current is supplied to the radiators 74a and 74b, the supply of the current to the heating wire 61 is not hindered. The heating wire 61 is supplied with a current having an accurate current value. The protrusion amount of the thin film magnetic head element 46 is controlled with high precision. In addition, the radiators 74a and 74b are sufficiently away from the thin film magnetic head element 46 or the heating wire 61. The heat that is dissipated from the radiators 74a and 74b is prevented from being transmitted to the heating wire 61. As a result, the heating wire 61 can protrude the thin film magnetic head element 46 with high precision.

In this case, effects of when the radiators 74a and 74b contact the wiring pattern 73 and do not contact the wiring pattern 73 are verified. At the time of the verification, a rectangular body of copper and a rectangular body of alumina with the same surface area S and length L are prepared. The temperature difference of both ends of the copper and the aluminum is defined as ΔT. At this time, the amount Q of heat that is transmitted from one end of the rectangular body to the other end is defined by an equation of kSΔT/L. The copper has thermal conductivity k of about 400 [W/mK]. The alumina has thermal conductivity k of about 20 [W/mK]. From the above equation, the amount of heat Q is proportional to the thermal conductivity k. Accordingly, if the radiators 74a and 74b formed of the copper contact the wiring pattern 73, the thermal conductivity is greatly improved as compared with the case where the insulating layer of alumina is interposed between the wiring pattern 73 and the radiators 74a and 74b.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head slider, comprising:
a slider main body;
an insulating nonmagnetic film layer on an end surface of the slider main body at an air outflow side;
a head element in the nonmagnetic film layer;
a heater in the nonmagnetic film layer in association with the head element;
a conductive terminal on an end surface of the nonmagnetic film layer at the air outflow side;
a conductive pattern configured to electrically connect the heater and the conductive terminal with each other; and
a radiator configured to contact the conductive pattern and to dissipate heat from the conductive pattern.

2. The head slider of claim 1, wherein the radiator comprises a conductive metal material.

3. The head slider of claim 1, wherein a distance between the radiator and the heater is greater than a distance between the radiator and the conductive terminal.

4. A storage medium driving device, comprising:
a support body;
a slider main body supported by the support body;
an insulating nonmagnetic film layer on an end surface of the slider main body at an air outflow side;
a head element in the nonmagnetic film layer;
a heater in the nonmagnetic film layer in association with the head element;
a conductive terminal on an end surface of the nonmagnetic film layer at the air outflow side;
a conductive pattern configured to electrically connect the heater and the conductive terminal with each other; and
a radiator configured to contact the conductive pattern and to dissipate heat from the conductive pattern.

5. The storage medium driving device of claim 4, wherein the radiator comprises a conductive metal material.

6. The storage medium driving device of claim 4, wherein a distance between the radiator and the heater is greater than a distance between the radiator and the conductive terminal.
